(19) United States
(12) Patent Application Publication
(10) Pub. No.: US 2011/0247896 A1
(43) Pub. Date: Oct. 13, 2011

(54) "TSL" Tool Storage Ladder

(75) Inventor: Anthony Michael Maglieri, Camarillo, CA (US)

(73) Assignee: Anthony Michael Maglieri, Camarillo, CA (US)

(21) Appl. No.: 12/759,663

(22) Filed: Apr. 13, 2010

(51) Int. Cl. E06C 7/14

(52) U.S. Cl. 182/129

(57) ABSTRACT

The tool storage ladder is an “A frame type ladder designed without a warning rung and in place of the common ladder warning rung is a tool storage compartment. The tool storage ladder is designed to stop the use of the warning rung on an “A” frame type ladder and completely stop ladder warning rung accidents on an “A frame type ladder. The compartment can be made from metal, fiberglass, wood or plastic composite. The ladder can also be made from metal, fiberglass, wood or plastic composite.

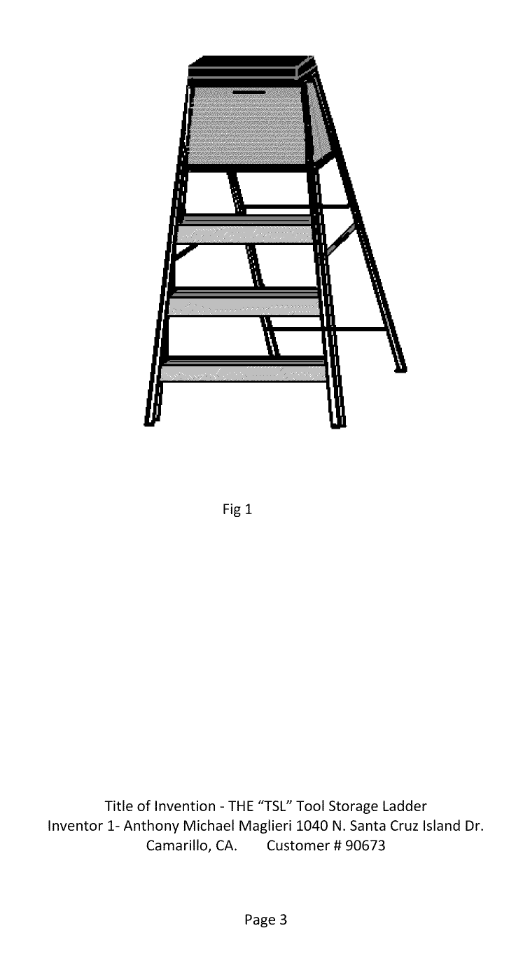

FIG. 1 shows the overall view of the “TSL” Tool Storage ladder with the enclosed top warning rung area. This enclosed area is will support the storage of tools.

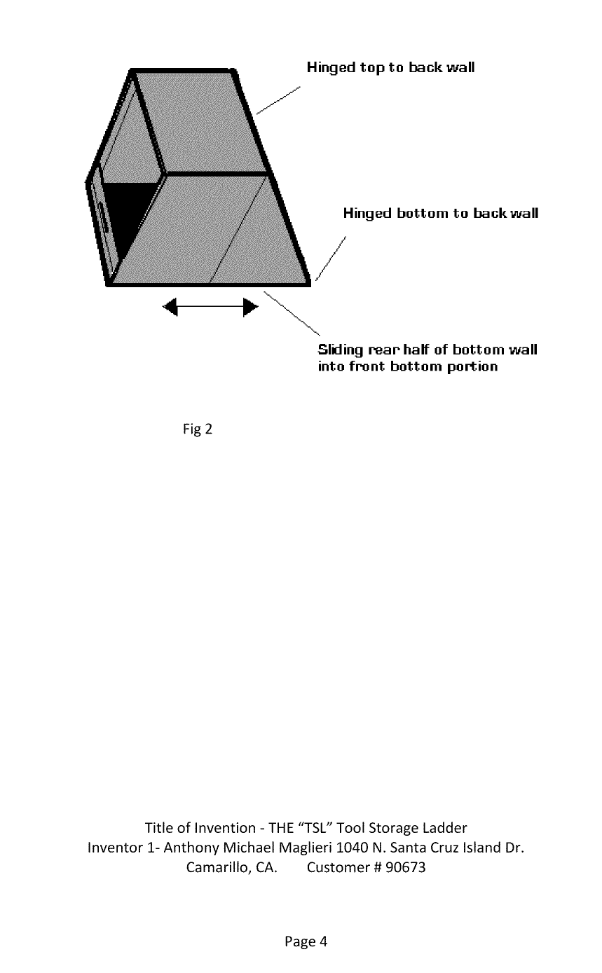

FIG. 2 shows the hinged areas that allow closure of the storage area as well as the direction by arrows of the bottom sliding portion into the front bottom portion.

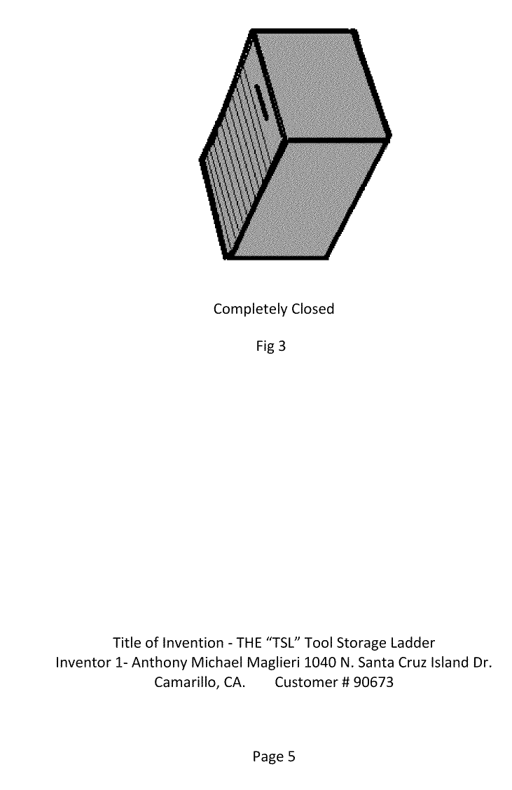

FIG. 3 shows the top rung enclosure completely closed.

The drawing with markings shows the open ladder compartment as if the ladder was open or extended and the drawing of the closed compartment is showing what the compartment looks like when the ladder is closed .

1. The tool storage ladder is an “A frame type ladder designed without a warning rung and in place of the common ladder warning rung is a tool storage compartment. The tool storage ladder is designed to stop the use of the warning rung on an “A” frame type ladder and completely stop ladder warning rung accidents on an “A frame type ladder. The compartment can be made from metal, fiberglass, wood or plastic composite. The ladder can also be made from metal, fiberglass, wood or plastic composite.
